(19) United States
(12) Patent Application Publication
(10) Pub. No.: US 2026/0178603 A1
(43) Pub. Date: Jun. 25, 2026

(54) DATA FORMAT SCALING AND CONVERSION TECHNIQUES

(71) Applicants: ADVANCED MICRO DEVICES, INC., Santa Clara, CA (US); XILINX, INC., San Jose, CA (US); Xilinx Technology Beijing Limited, Beijing (CN)

(72) Inventors: Stuart David Simpson Biles, Edmunds (GB); Michael J. Schulte, Austin, TX (US); Eric Ford Dellinger, Longmont, CO (US); Ralph Wittig, Menlo Park, CA (US); Dong Li, Beijing (CN); Tiantian Han, Beijing (CN)

(21) Appl. No.: 18/999,423

(22) Filed: Dec. 23, 2024

(51) Int. Cl. G06F 16/25

(52) U.S. Cl. CPC G06F 16/258

(57) ABSTRACT

A flexible microscaling (MX) approach allows for the dynamic selection between multiple scale determination functions to compute a scaling factor that delivers lower deviation from an input data array when converting the input data array to an output data array with reduced bit precision. The flexible MX approach includes selecting a first scale determination function from a plurality of scale determination functions based on a characteristic of an input data array having a first data format, computing a scaling factor based on the first scale determination function, and converting the input data array into an output data array having a target data format based on the selected scaling factor. The output data array is then input to an artificial intelligence (AI) model for processing.

### BACKGROUND

Processing systems executing Artificial Intelligence (AI) models, such as machine learning (ML) models, use large amounts of data in vectors, matrices, and tensors (collectively herein referred to as “data arrays”). These data arrays can be the input or output of the AI model, the model weights, the activations, or other data used by the AI model. To execute AI models, a processing system receives a data array (e.g., retrieves the data array from a memory), and, in some cases, converts the data array into a target data format type that is compatible with downstream hardware (e.g., matrix multipliers or adders in compute units of the processing system). Once converted, the data array is represented and processed in the target data format type.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of a processing system for scaling data using a dynamic scaling factor approach in accordance with some embodiments.

FIG. 2 shows an example of a conversion circuitry employing a dynamic scaling factor approach for converting data having a first data format to a target data format in accordance with some embodiments.

FIG. 3 shows another example of a conversion circuitry employing a dynamic scaling factor approach for converting an input data array having a single-precision floating-point format occupying 32 bits (FP32 data format) to an output data array having in a reduced bit format in accordance with some embodiments.

FIG. 4 shows an example of a flowchart illustrating a dynamic scaling factor approach based on the mantissa bits of an input data array in accordance with some embodiments.

### DETAILED DESCRIPTION

The data format of data arrays used in the execution of an AI model can affect the performance of the processing system. For example, the data array may be in a data format that increases the computational bandwidth or the memory footprint of executing the AI model at the processing system. Therefore, in some cases, it can be beneficial to convert the data format of a data array retrieved from a memory (or received from another processing component) to a different data format to improve AI model processing performance. Microscaling (MX) employs a scale determination function to compute a scaling factor (also referred to as a “shared scale”) to scale an initial data array (also referred to herein as an “input data array”) having a first data format to facilitate conversion of the input data array to an output data array having a target data format. Generally, the target data format includes fewer bits than the input data format. In this manner, MX enables AI model training and inferencing with lower bit-width arithmetic operations and smaller memory footprints that seek to improve hardware performance.

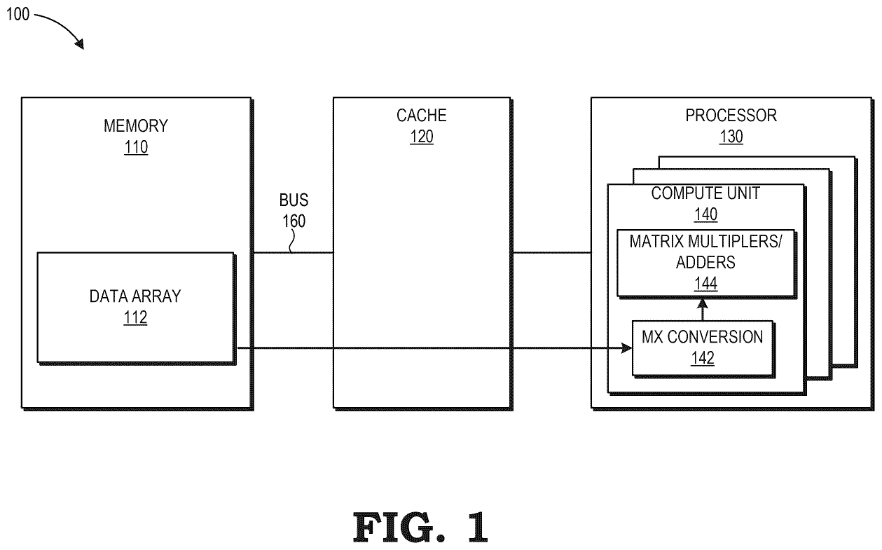

Conventional MX techniques are susceptible to higher levels of saturation noise attributed to data truncation and rounding errors when scaling and converting the input data array to the output data array. This sometimes leads to a lower quality output from the AI model due to the relatively large deviation between the input data array and the output data array. The techniques described in FIGS. 1-4 provide a flexible MX approach that dynamically selects between multiple scale determination functions to compute a scaling factor that delivers lower deviation between the output data array and the input data array compared to a conventional MX approach that is based on a single scale determination function, thereby improving the performance and the output quality of the AI model.

To illustrate, a processing system sometimes employs a single-precision floating-point format occupying 32 bits (referred to herein as “FP32” for brevity) to execute applications at processors such as a central processing unit (CPU) or an accelerated processing unit (APU) (e.g., a graphics processing unit (GPU), an artificial intelligence (AI) engine unit, or the like). The FP32 data arrays typically represent a wide dynamic range of numeric values with a floating radix point to provide high precision. However, processing the FP32 data arrays can be computationally expensive, especially for processing systems executing AI applications such as ML models that use large amounts of data and perform many computations in parallel. Therefore, in some cases, it may be beneficial for the processing system to convert the FP32 data array into lower bit data formats such as 4-bit, 6-bit, or 8-bit data formats.

Although converting the FP32 data array to a lower bit data format reduces the memory footprint and increases the number of computations that can be performed in parallel at the processing system, the converted data array typically has a lower dynamic range than the initial data array. For example, to illustrate the difference in the bits of different data format types, the FP32 data format includes 1 sign bit, 8 exponent bits, and 23 mantissa bits. On the other hand, the MX data formats include a 4-bit floating point format (FP4) with 1 sign bit, 2 exponent bits, and 1 mantissa bit; a first 6-bit floating point format (FP6) with 1 sign bit, 3 exponent bits, and 2 mantissa bits; a second FP6 with 1 sign bit, 2 exponent bits, and 3 mantissa bits; a first 8-bit floating point format (FP8) with 1 sign bit, 5 exponent bits, and 2 mantissa bits; and a second FP8 with 1 sign bit, 4 exponent bits, and 3 mantissa bits. As such, converting data in a data array from a FP32 data format to one of the MX data formats generally results in both decreased mantissa bit resolution and decreased exponent range since the MX data formats cannot express as wide a range of exponent or mantissa bit values.

Conventional MX approaches employ a single scale determination function to compute a scaling factor (also referred to as a “shared scale”) to scale an input data array prior to conversion to mitigate the loss of mantissa bit resolution when converting to one of the MX data formats. Conventionally, the scale determination function computes the scaling factor to be the largest power-of-two less than or equal to the maximum magnitude value in the input data array (i.e., the value with the largest absolute value), divided by the largest power-of-two representable in the target data format. The conventional conversion process also includes truncating and rounding the input data array (e.g., the FP32 data array) mantissa bits to fit within the encoding space of the target MX data format. However, the scaling of the input data array (after truncating and rounding) with the conventional scale determination function, in some cases, exceeds the target data format maximum value, resulting in saturation and larger deviation errors between the input data array and the output data array. An alternative to the conventional scale determination could be selected, for example, by computing the scaling factor to be the largest power-of-two less than or equal to the maximum magnitude value in the input data array (i.e., the value with the largest absolute value), divided by the largest power-of-two representable in the target data format plus one. The alternative scale will avoid saturation when converting the largest magnitude numbers in the input array. It has the disadvantage of potentially losing mantissa accuracy of smaller magnitude numbers, up to and including rounding down to zero. If the largest magnitude numbers would not have been saturated when using the conventional scale determination function, then overall accuracy for the output data array will be optimized when using the conventional scale determination function.

The embodiments presented herein provide a flexible MX scaling approach that dynamically selects between multiple scale determination functions to select a scaling factor that delivers lower deviation between the output data array and the input data array compared to conventional approaches that are based on a single scale determination function. In some embodiments, a processing system includes a processor with one or more compute units to perform computations for an AI model such as an ML model. The one or more compute units include hardware, software, or a combination thereof, to execute matrix multiplication, matrix addition, or other operations associated with the AI model. For example, the one or more compute units include matrix multiplication or addition circuitry in the form of floating-point units (FPUs) or arithmetic logic units (ALUs).

The one or more compute units are configured to receive a data array having a first data format and convert the data array to an output data array having a target data format that is different from the first data format based on a scaling factor. The scaling factor is computed based on selecting a first scale determination function from multiple scale determination functions. In some embodiments, the selection of the first scale determination function is based on a characteristic of the data array. For example, in some embodiments, the characteristic is associated with a first plurality of mantissa bits of the input data array and a data format conversion impact of converting the first plurality of mantissa bits into one or more mantissa bits in the output data array having the target data format. The data format conversion impact is, in some cases, indicative of a saturation impact of truncating and rounding the leading mantissa bits from the first data format (e.g., an FP32 data format) to the target data format (e.g., one of the MX data formats). In this manner, the processing system implements a flexible approach that dynamically selects one of multiple scale determination functions to compute a scaling factor that minimizes truncation and rounding errors when converting the input data array to the output data array.

In some embodiments, any of the elements, components, or blocks shown in the ensuing figures are implemented as one of software executing on a processor, hardware that is hard-wired (e.g., circuitry) to perform the various operations described herein, or a combination thereof. For example, one or more of the described blocks or components (e.g., the components of the MX conversion circuitry associated with the techniques described herein) represent software instructions that are executed by hardware such as a digital signal processor (DSP), an application-specific integrated circuit (ASIC), a set of logic gates, a field programmable gate array (FPGA), a programmable logic device (PLD), a hardware accelerator, a graphics processing unit (GPU), a neural network (NN) accelerator, an artificial intelligence (AI) accelerator, or other type of hardcoded or programmable circuit.

FIG. 1 shows an example of a processing system 100 including a memory 110 and processor 130 including one or more compute units 140 with MX conversion circuitry 142 that dynamically computes a scaling factor by selecting between multiple scale determination functions based on the mantissa bits of an input data array 112, in accordance with some embodiments. While the embodiments herein are discussed in the context of an AI or ML processing system, they are not limited to such. That is, in other embodiments, the techniques described herein are used in other applications that involve scaling and converting between different data formats.

For ML applications, large amounts of data such as weight tensors, activations, input/output, and the like are frequently moved from the memory 110 to the compute units 140 that perform ML operations such as matrix multiplications, matrix additions, or other ML operations. In some cases, the memory 110 is a main memory (e.g., RAM) and, in other cases, the memory 110 includes storage (e.g., solid state drives or hard disk drives). In some embodiments, the memory 110 is coupled to a cache 120 via a bus 160. The bus 160 also couples the cache to the processor 130. The cache 120 includes any number cache levels (e.g., L2/L3 cache).

The processor 130 includes compute units 140 for performing the ML operations using the data array 112 retrieved from the memory 110. In some cases, the data array 112 is referred to as an input data array and has a first data format that is converted by the processor 130 (e.g., via the MX conversion circuitry 142 in the one or more compute units 140) to an output data array (not shown) with a target data format to improve the performance of executing the ML operations at the compute units 140. In the illustrated embodiment, the compute units 140 include matrix multipliers/adders 144 to execute ML operations, but this is only one example of circuitry that may be in the compute units 140.

In some embodiments, the processor 130 is one or more of a central processing unit (CPU), a graphics processing unit (GPU), a field programmable gate array (FPGA), a system on a chip (SoC) that includes an array of artificial intelligence (AI) engines, or the like. For example, the compute units 140 are cores in a CPU, or a workgroup or a processing tile in a GPU. In some embodiments, the compute units 140 include vector processors (e.g., single instruction, multiple data (SIMD)) or streaming multiprocessors (SM) and memory (e.g., registers). In some cases, the compute units 140 are assigned to workgroups by a programmer to execute wavefronts. In other examples, one or more compute units 140 may be assigned to a kernel. If the processor 130 is an FPGA, the compute units 140 are formed using programmable logic in contrast to hardened circuitry or hardened logic, for example.

In some embodiments, the processor 130 retrieves the data array 112 from the memory 110 (or in other embodiments, the processor 130 retrieve the data array 112 from the cache 120) in a first data format (e.g., an FP32 data format). In some cases, processing the data from the data array 112 in the first data format type at the compute units 140 may consume computational bandwidth or occupy a memory footprint that adversely impacts the performance of the hardware. As such, the compute unit 140 may benefit from converting the data array 112 having the first data format to an output data array in a target data format with fewer bits than the first data format. For example, in some embodiments, the first data format is an FP32 data format, and the target data format is an MX floating-point (FP) data format with fewer bits compared to the FP32 data format.

To this end, the compute unit 140 includes MX conversion circuitry 142 to convert the data array 112 having the first data format to an output data array having a target data format for processing at the matrix multipliers/adders 144 of the compute unit 140. The MX conversion circuitry 142 includes a hardware, software, or a combination thereof, that is configured to inspect the data array 112 and select a scale determination function from a plurality of scale determination functions based on the mantissa bits of the data array 112. In some cases, the selection of the appropriate scale determination function depends in part on the mantissa bits of the largest magnitude element of the data array 112. For example, in some embodiments, the selection of the appropriate scale determination function depends in part on the mantissa bits of the data array 112 and a data format conversion impact of converting the mantissa bits of the input data array 112 into one or more mantissa bits of the output data array having the target data format. In some embodiments, each one of the mantissa bits of the input data array is either a “1” or a “0” and corresponds to a fractional value in finer resolution. For example, if there are three mantissa bits “101”, the first mantissa bit (“1”) corresponds to ½, the second mantissa bit (“0”) corresponds to ¼, and the third mantissa bit (“1”) corresponds to a ⅛, for a total mantissa bit value of 0.375. The MX conversion circuitry 142 computes a scaling factor using the selected scale determination function to generate a scaled data array including one or more scaled data format blocks, and then converts the scaled data array into an output data array having the target data format (e.g., one of the MX data formats) for processing at the compute unit 140 such as at the matrix multipliers/adders 144. By dynamically selecting an appropriate scale determination function to compute the scaling factor, the MX conversion circuitry 142 generates a more accurate output data array (relative to the data array 112) compared to conventional MX approaches that employ a single scale determination function, thereby improving the output of an application (e.g., an AI model) executing at the compute units 140.

While FIG. 1 illustrates using the MX conversion circuitry 142 when moving data into the compute units 140, this is just one example. In some AI and ML applications, the data formats are evolving toward shorter data format types. The motivation is to perform more operations quicker (and shorter datatypes are easier and faster to operate on) and make more efficient use of available memory bandwidth and capacity. As such, the processing system 100 may process and convert data within the processor 130 (e.g., from one compute unit 140 to another one of the compute units 140) using the same MX conversion techniques described herein.

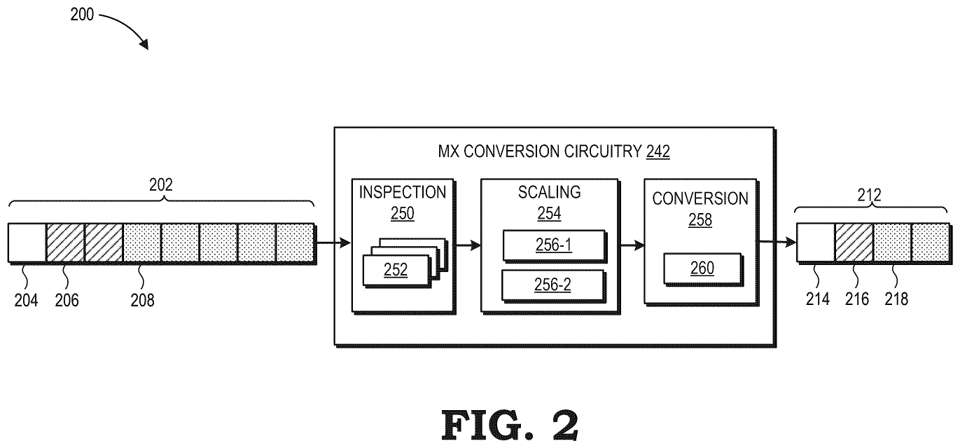

FIG. 2 shows an example diagram 200 of an MX conversion circuitry 242 converting an input data array 202 having a first format to an output data array 212 having a target data format in accordance with some embodiments. In some embodiments, the input data array 202 represents a plurality of values in the first data format, where each value of the plurality of values in the input data array 202 includes a sign bit 204, exponent bit(s) 206, and mantissa bit(s) 208. That is, while the embodiment illustrated in FIG. 2 shows the input data array 202 as an array of bits (with one sign bit 204, two exponent bits 206, and five mantissa bits 208), in other embodiments, the input data array 202 includes multiple such arrays, each having respective sign, exponent, and mantissa bits. In some embodiments, the MX conversion circuitry 242 corresponds to the MX conversion circuitry 142 of FIG. 1. For example, the MX conversion circuitry 242, in some embodiments, is included in a compute unit of a processor such as in the compute unit 140 of the processor 130 of FIG. 1.

The MX conversion circuitry 242 receives the input data array 202 from another component of a processing system that includes the MX conversion circuitry 242. For instance, referring to FIG. 1 by way of example, the MX conversion circuitry 242 receives the input data array 202 from the memory 110 or the cache 120 via bus 160.

The input data array 202 is in a first data format and includes a predefined number of bits that are based on the first data format. In the illustrated embodiments, the data value bits are represented by the different shaded boxes. For example, in the illustrated embodiments, the input data array 202 is shown as include one sign bit 204, two exponent bits 206 (only the first exponent bit is labeled for clarity purposes), and a plurality of mantissa bits 208 (only the first mantissa bit is labeled for clarity purposes). In the illustrated embodiments, the number of bits in the plurality of mantissa bits 208 is five, but in other embodiments, the number of bits in the plurality of mantissa bits is another number. For example, if the input data array 202 is in the FP32 data format, the number of bits in the plurality of mantissa bits 208 is 23.

The MX conversion circuitry 242 includes inspection circuitry 250 that inspects the input data array 202 to determine one or more characteristics of the input data array 202. For example, in some cases, the inspection circuitry 250 determines which set of mantissa bits to examine by first identifying the largest magnitude element within the input data array 202 (which may involve examining both the exponent bits 206 and the mantissa bits 208 of the input data array 202). In some embodiments, one characteristic of the one or more characteristics is based on the number of bits in the plurality of mantissa bits 208 of the input data array 202. In some cases, the inspection circuitry 250 looks at a predefined number of leading mantissa bits of the plurality of mantissa bits 208 based on the target data format of the output data array 212. In some embodiments, the inspection circuitry 250 looks at a predefined number of leading mantissa bits of the plurality of mantissa bits 208 corresponding to the number of mantissa bits 218 in the output data array 212 plus one. For example, if the target data format of the output data array 212 includes two mantissa bits 218, the inspection circuitry 250 looks at the first 3 mantissa bits of the plurality of mantissa bits 208.

In some embodiments, a second characteristic of the one or more characteristics is based on the data format conversion impact of converting the plurality of mantissa bits 208 of the input data array 202 to the number of mantissa bits 218 of the output data array 212. For example, in some cases, the inspection circuitry 250 determines the saturation impact of rounding the plurality of mantissa bits 208 of the input data array 202 to the mantissa bits 218 in the output data array 212. To determine the saturation impact, the inspection circuitry 250 includes one or more threshold values 252 that is it uses as a comparison point with the predefined number of leading mantissa bits. Each threshold value 252 is associated with an MX data format of a plurality of MX data formats to be used in the output data array 212. For example, the inspection circuitry 250 uses a first threshold value of the threshold values 252 when the target data format of the output data array 212 is an MX FP4 data format having one mantissa bit. In the case of using the first threshold value, the inspection circuitry 250 looks at a first subset of mantissa bits of the plurality of mantissa bits 208 of the input data array 202 and compares the first subset to the first threshold value to determine a data format conversion impact of converting the plurality of mantissa bits 208 of the input data array 202 to the number of mantissa bits 218 of the output data array 212. For example, for converting from a data format with 23 mantissa bits to a target data format with 1 mantissa bit, the inspection circuitry 250 looks at the first two bits [22:21] out of the 23 bit mantissa [22:0] and compared to a first threshold of 11b. The inspection circuitry 250 passes the one or more characteristics (e.g., the data format conversion impact of converting the plurality of mantissa bits 208 of the input data array 202 into one or more mantissa bits 218 of the output data array 212 having the target data format) to a scaling circuitry 254.

In some embodiments, the first threshold value allows for the inspection circuitry 250 to decide whether the value(s) of the input data array ought to round up to the next power of two when rounded to the number of mantissa bits available in the target data format of the output data array. In some cases, rounding up to the next power of two would require the exponent to increase by 1, but, in some cases, this is not possible if the scale has already been determined to site the scaled number at the maximum exponent available in the target data format (resulting in saturation when using the existing block scale function). When the rounding mode being applied is round to nearest even (RTNE), the general (although some formats have more complex needs—the FP8 E3M4 format with 3 exponent bits and 4 mantissa bits has additional encoding complications) threshold check here is to examine the input data array mantissa bits that will remain in the target data format (e.g., one bit in the case of FP4 E2M1, where E2 refers to two exponent bits and M1 refers to one mantissa bit), and the mantissa bit immediately below this. If all these bits are “1”, then the RTNE would require rounding upwards, to 1.0 and the next power of 2. To allow this, the scaling circuitry 254 selects an alternate scale value allowing the round up to occur without saturation. An alternate view of this rounding using an alternate scale value (e.g., via one of the multiple scale determination functions 256-1, 256-2) is mathematically stated in the following paragraph.

The target data format has a maximum magnitude value that can be represented (“maxfloat”). In some cases, maxfloat is formed from the combination of a target format maximum exponent (emax) and target format maximum mantissa (mmax), where mmax is 1.0+the fraction represented by the mantissa bits in the target data format encoding. That is, maxfloat=mmax*2\hat{ }emax. The absolute maximum value (ignoring exceptional values) can also be represented by absmax_m*2\hat{ }absmax_e. In an FP32 data format, absmax_m will be a value between 0 and 2−2\hat{ }−23. During rounding to the target data format, absmax_m may need to round to a fraction less than or equal to mmax. Alternatively, absmax_m may need to round to a value larger than mmax (mmax_inc). Thus, a value, midmax, can be defined which lies halfway between the fractional values of mmax_inc and mmax: midmax=(mmax_inc-mmax)/2.0+mmax. If absmax_m is greater than or equal to midmax, then under RTNE, absmax_m needs to round to a larger value away from mmax (and would need to saturate unless an alternate scale selected). For example, with the majority of OCP MX formats, the mmax_inc will be the value 2.0. As such, a value for midmax, which lies halfway between the fraction mmax and 2.0, can be defined as follows:

midmax = (2.0 − mmax) / 2.0 + mmax;
if (absmax_m >= midmax) {
// scale circuitry uses scale_2
} else {
// scale circuitry uses scale_1
}

This mathematical comparison is equivalent to examining the high order mantissa bits (the additional bit after the mantissa bits retained is equivalent to being halfway to the next power of two).

Put differently, in some embodiments, the MX conversion circuitry 242 (including the inspection circuitry 250, the scaling circuitry 254, and the conversion circuitry 258) is configured to execute code which implements two expanded data format conversion methods. The first method, “midmax,” calculates a point in the fraction space that is halfway between the maximum fraction expressible in the target data type and the next largest value that should not be rounded up to in order to avoid saturation. Typically, this next largest value will be 2.0 and the target data type maximum fraction will be of the form 1.mmm (3 mantissa fractional bits in this case-representing 1.875). If the fractional value (implicit 1.0+mantissa) of the absolute maximum value is greater than or equal to this midmax point, then the number would round up, and the scaling circuitry 254 selects an alternate scale determination function to determine the scaling factor. The comparison performed is examining the mantissa of absolute maximum value and interpreting as a fraction, for comparison with the midmax value. The second method performs the same function essentially but examines the upper mantissa bits of the absolute maximum value using a logical comparison. The number of bits examined is equal to the number of mantissa bits in the target data format plus one. For the majority of data types of interest, that additional bit represents the same fractional value as the midmax point.

In some cases, the inspection circuitry 250 determines the one or more characteristics of the input data array 202 based on one or more heuristic approaches. In a first approach, the inspection circuitry 250 determines whether at least one largest magnitude element (e.g., the absolute max (absmax) value) of the input data array 202 would saturate if the first scale determination function were used. If so, the inspection circuitry 250 indicates to the scaling circuitry 254 to use the second scale determination function. In a second approach, the inspection circuitry 250 evaluates errors introduced by saturating the largest magnitude elements of the input data array 202 versus lost mantissa bit resolution or underflow (e.g., conversion to zero) of the smallest magnitude elements of the input data array 202. For example, if the sum of the saturation of the largest magnitude elements is greater than the sum of the lost mantissa bit resolution of the smallest magnitude elements, then the inspection circuitry 250 indicates to the scaling circuitry 254 to select the scale determination function (e.g., the second scale determination function 256-2) that better preserves the large magnitude elements. In a third approach, the inspection circuitry 250 employs a combination of the two aforementioned approaches to balance complexity and improvement in numerical accuracy.

The scaling circuitry 254 includes multiple scale determination functions 256-1, 256-2. Based on the one or more characteristics determined from the inspection circuitry 250, the scaling circuitry 254 selects one of the scale determination functions 256 to compute a scaling factor. In some embodiments, the first scale determination function 256-1 corresponds to the scale determination function defined in the text of Section 6.3 of the Open Compute Project (OCP) MX Specification, Version 1.0. That is, the first scale determination function 256-1 sets the scaling factor (X) to be the largest power-of-two less than or equal to a largest magnitude value in the input data array divided by a largest power-of-two representable in the target data format. In some embodiments, the second scale determination function 256-2 sets the scaling factor to be a largest power-of-two less than or equal to a largest magnitude value in the input data array divided by a largest power-of-two representable in the target data format and increased by an additional power-of-two. That is, the second scale determination function 256-2 increases the scaling factor by a power-of-two compared to the first scale determination function 256-1. In this manner, the second scale determination function 256-2 provides additional headroom for the scaling factor that will allow for rounding up of the plurality of mantissa bits 208 of the input data array 202 when converting to the target data format of the output data array 212 without requiring saturation.

If the inspection circuitry 250 provides an indication that the additional headroom for mantissa bit conversion from the input data array 202 to the output data array 212 is beneficial (e.g., in cases where the plurality of mantissa bits 208 of the input data array 202 include larger magnitude values), the scaling circuitry 254 selects the second scale determination function 256-2 to compute the scaling factor. And, in cases where the inspection circuitry 250 provides an indication that the additional headroom for mantissa bit conversion from the input data array 202 to the output data array 212 is not needed (e.g., in cases where the inspection circuitry 250 indicates that rounding up of the mantissa bits will not occur as compared to the one or more thresholds 252), the scaling circuitry 254 selects the first scale determination function 256-1 to compute the scaling factor. Once the scaling circuitry 254 generates the scaling factor by selecting one of the scale determination functions 256, the scaling factor 260 and the corresponding data array (e.g., the scaled version of the input data array 202, not shown) are sent to the conversion circuitry 258 for conversion to the output data array 212 having the target data format. As shown in the illustrated embodiments, the output data array 212 has a target data format that includes fewer bits than the input data array. For example, the output data array 212 has one sign bit 214, one exponent bit 216, and two mantissa bits 218.

In this manner, the MX conversion circuitry 242 implements a flexible MX approach that dynamically selects between multiple scale determination functions 256 to compute a scaling factor that delivers lower deviation between the output data array 212 and the input data array 202 compared to a conventional MX approach that is based on a single scale determination function. The output data array 212 is then fed to one or more parallel processing units (e.g., one or more of the matrix multipliers or adders 144 FIG. 1) for use in executing an AI model. By generating the output data array 212 in the manner shown in FIG. 2, the performance and output quality of the AI model executed at the processor is improved.

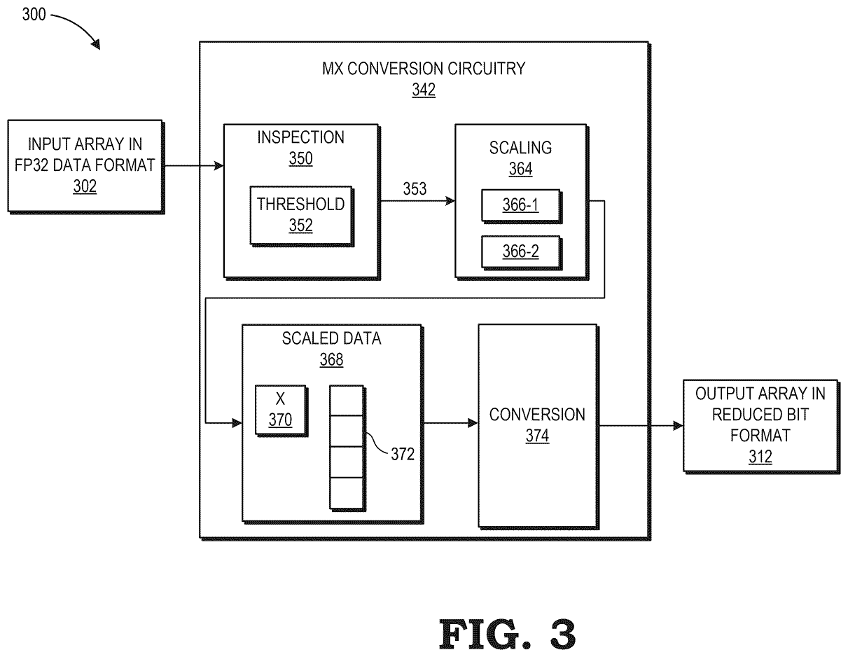

FIG. 3 shows an example diagram 300 of an MX conversion circuitry 342 converting an input data array 302 in an FP32 data format to an output data array 312 in a reduced bit data format (e.g., such as one of the aforementioned MX data formats) in accordance with some embodiments. In some embodiments, the MX conversion circuitry 342 corresponds to the MX conversion circuitry 142 of FIG. 1 or the MX conversion circuitry 242 of FIG. 2. For example, in some cases, the MX conversion circuitry 342 is included in a compute unit of a processor such as in the compute unit 140 of the processor 130 of FIG. 1. The MX conversion circuitry 342 receives the input data array 302 having the FP32 data format from another component of a processing system that includes the MX conversion circuitry 342. For instance, referring to FIG. 1 by way of example, the MX conversion circuitry 342 receives the input data array 202 from the memory 110 or the cache 120 via the bus 160.

In the illustrated example, the data of the input data array 302 is in the FP32 data format. As such, the input data array 302 has data values with 1 sign bit, 8 exponent bits, and 23 mantissa bits. While FP32 data arrays such the input data array 302 represent a wide dynamic range of numeric values with a floating radix point to provide high precision, the processing of such data arrays at an AI model consumes a large amount of computational bandwidth and occupies a large memory footprint of executing the AI model. Therefore, the MX conversion circuitry 342 is configured to convert the input data array 302 having the FP32 data format to the output data array 312 having a reduced bit data format to improve the performance of an AI model using the data.

The MX conversion circuitry 342 includes inspection circuitry 350 to receive the input array 302 and inspect the exponent and mantissa bits of the data values in the input array 302 to determine one or more characteristics of the input array 302. For example, in some cases, the inspection circuitry 250 inspects the exponent and mantissa bit values to select the largest magnitude value element in the input data array 302, e.g., absmax (X), where X represents the elements in the input data array 302. The inspection circuitry 350 inspects the selected leading mantissa bits of the input data array 302 and compares the leading mantissa bit values to a threshold 352. In some cases, the threshold 352 is selected so as to indicate a data format conversion impact of converting from the input data array 302 in the FP32 data format to the output data array 312 in the reduced bit format. For example, if the selected leading mantissa bit values of the input data array 302 (e.g., the selected leading mantissa bit value resulting from the aforementioned absmax (X) determination) do not exceed the threshold 352, the inspection circuitry 350 outputs a comparison result 353 that indicates to the scaling circuitry 364 to select a first scale determination function 366-1. If the leading mantissa bit values of the input data array 302 exceed the threshold 352, the inspection circuitry 350 outputs a comparison result 353 that indicates to the scaling circuitry 364 to select a second scale determination function 366-2. Based on the comparison result 353 output by the inspection circuitry 350, the scaling circuitry 364 selects one of the two scale determination functions 366 to compute a scaling factor X 370 for scaled data 368 corresponding to the input array 302. The scaled data 368 also includes a plurality of scalar elements 372, each corresponding to one of the data elements in the input array 302. The conversion circuitry 374 receives the scaled data 368 from the scaling circuitry 364 and converts the scaled data to the output array 312 in the reduced bit format (e.g., one of the MX data formats). For example, in some embodiments, the conversion circuitry 374 multiplies the scaling factor X 370 by the plurality of scalar elements 372 to convert to the output array 312 in the reduced bit format as part of the conversion process.

As illustrated in FIG. 3, the MX conversion circuitry 342 implements a flexible MX approach that dynamically selects between multiple scale determination functions 356 to compute a scaling factor X 370 to deliver lower deviation between the output data array 312 and the input data array 302 compared to a conventional MX approach that is based on a single scale determination function. The output data array 312 is then fed to one or more parallel processing units (e.g., one or more of the matrix multipliers or adders 144 FIG. 1), thereby improving the performance and output quality of an AI model executing at the one or more parallel processing units.

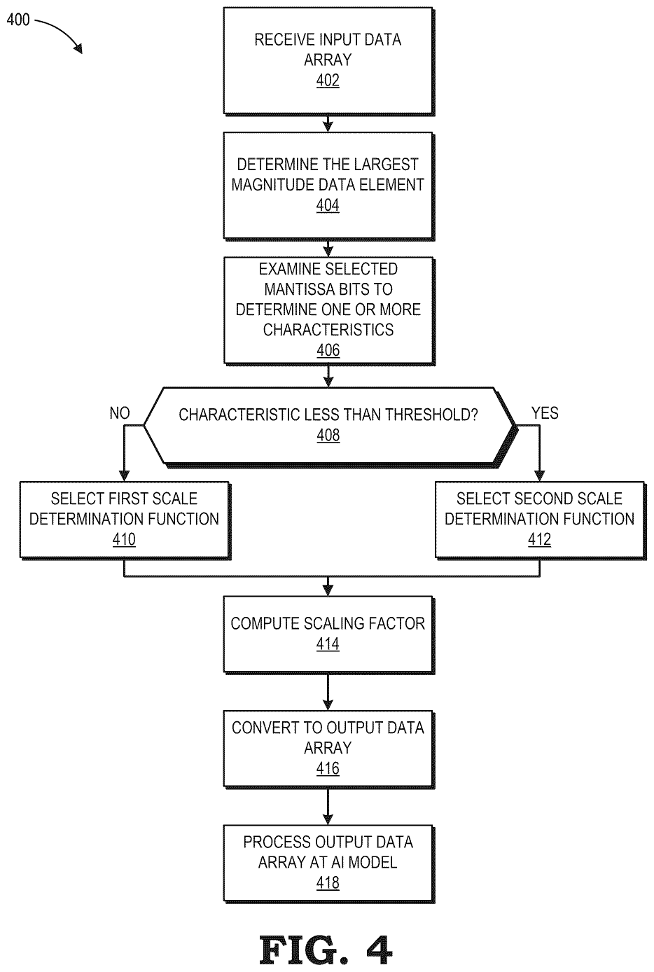

FIG. 4 shows an example of a flowchart 400 illustrating a flexible MX method, executed at a processor, that dynamically selects between multiple scale determination functions to compute a scaling factor in accordance with some embodiments. In some embodiments, the method shown in flowchart 400 is implemented by a processor at an MX conversion circuitry such as at the MX conversion circuitries 142, 242, 342 of FIGS. 1-3, respectively.

At block 402, the processor receives the input data array. In some cases, the input data array is in a first data format such as an FP32 data format.

At block 404, the processor inspects the input data array received at block 402 to determine the input data array element with the largest magnitude. For example, the processor includes inspection circuitry such as the inspection circuitry 250, 350 of FIGS. 2 and 3, respectively, to inspect the exponent and mantissa bits of the elements of the input data array. The inspection circuitry applies an absolute maximum function (e.g., absmax( )) to the exponent and mantissa bit values of the input data array and selects the element of the input data array having the largest absolute value. The mantissa bits of this selected element are referred to herein as the “selected mantissa bits.”

At block 406, the processor examines the selected mantissa bits determined at block 404 to determine one or more characteristics. The characteristics, in some cases, are associated with the selected mantissa bits (e.g., a first plurality of mantissa bits) of the input data array and a data format conversion impact of converting the first plurality of mantissa bits of the input data array into one or more mantissa bits of the output data array having a target data format with fewer bits than the first data format of the input data array.

At block 408, the processor compares the one or more characteristics determined at block 406 to a threshold. For example, the inspection circuitry of the processor includes one or more threshold values such as thresholds 252, 352 of FIGS. 2 and 3, respectively. The threshold values indicate, at least in part, a rounding headroom for converting the input data array to an output data array with reduced mantissa bit resolution compared to the input data array. If the one or more characteristics determined at block 406 exceed the threshold, the processor proceeds to block 410 to select a first scale determination function. If the one or more characteristics determined at block 406 do not exceed the threshold, the processor proceeds to block 412 to select a second scale determination function.

Based on the scale determination function selected at one of blocks 410, 412, the processor computes a scaling factor at block 414. For example, the scaling factor corresponds to the scaling factor X 370 of the scaled data block 368 of FIG. 3. Then, at block 416, the processor converts the scaled data based on the input data array to the output data array with a reduced bit format (e.g., one of the MX data formats). At block 418, the output data array generated at block 416 is then fed to one or more parallel processing units executing an AI model. For example, the output data array generated at block 416 is input to the matrix multipliers or adders 144 of the compute unit 140 of FIG. 1.

In some embodiments, the apparatus and techniques described above are implemented in a system including one or more integrated circuit (IC) devices (also referred to as integrated circuit packages or microchips), such as the compute unit described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]-—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
computing, for an input data array having a first data format, a scaling factor based on a first scale determination function of a plurality of scale determination functions;
converting the input data array into an output data array having a target data format based on the scaling factor, wherein the output data array occupies a smaller memory footprint than the input data array; and
processing the output data array at an artificial intelligence (AI) model.

2. The method of claim 1, further comprising:
selecting the first scale determination function from the plurality of scale determination functions based on a characteristic of the input data array, wherein the characteristic is associated with a first plurality of mantissa bits of the input data array and a data format conversion impact of converting the first plurality of mantissa bits of the input data array into one or more mantissa bits of the output data array.

3. The method of claim 2, wherein the data format conversion impact is associated with truncating a subset of mantissa bits of the first plurality of mantissa bits of the input data array and rounding the truncated subset of mantissa bits to generate the one or more mantissa bits of the output data array.

4. The method of claim 3, wherein the scaling factor computed based on the first scale determination function reduces an error of rounding the truncated subset of mantissa bits to generate the one or more mantissa bits of the output data array compared to if the scaling factor was computed based on a second scale determination function of the plurality of scale determination functions.

5. The method of claim 2, further comprising:
selecting the first plurality of mantissa bits based on determining a largest magnitude value element of the input data array and using a subset of the largest magnitude value element's mantissa bits as the first plurality of mantissa bits;
inspecting the first plurality of mantissa bits of the input data array; and
selecting the first scale determination function based on a result of inspecting the first plurality of mantissa bits of the input data array, wherein the result is indicative of the data format conversion impact of converting the first plurality of mantissa bits of the input data array into one or more mantissa bits of the output data array having the target data format.

6. The method of claim 1, wherein the first scale determination function increases a shared scale of the scaling factor for converting input data values in the input data array having the first data format to output data values in the output data array having the target data format compared to a second scale determination function of the plurality of scale determination functions.

7. The method of claim 6, wherein the first scale determination function increases the shared scale of the scaling factor for converting the input data array having the first data format to the output data array having the target data format by a power-of-two compared to the second scale determination function of the plurality of scale determination functions.

8. The method of claim 1, wherein the first scale determination function is based on a scale that is set to be a largest power-of-two less than or equal to a largest magnitude value in the input data array divided by a largest power-of-two representable in the target data format increased by an additional power-of-two.

9. The method of claim 1, wherein the first data format is a single-precision floating point format, and the target data format is configured to occupy fewer bits than the single-precision floating point format.

10. (canceled)

11. A compute unit comprising circuitry configured to:
compute, for an input data array having a first data format, a scaling factor based on a first scale determination function of a plurality of scale determination functions; and
convert the input data array into an output data array having a target data format based on the scaling factor to process the output data array at an artificial intelligence (AI) model, wherein the output data array occupies a smaller memory footprint than the input data array.

12. The compute unit of claim 11, wherein the compute unit selects the first scale determination function from the plurality of scale determination functions based on a characteristic of the input data array, and wherein the characteristic is associated with a first plurality of mantissa bits of the input data array and a data format conversion impact of converting the first plurality of mantissa bits of the input data array into one or more mantissa bits of the output data array.

13. The compute unit of claim 12, wherein the data format conversion impact is associated with truncating a subset of mantissa bits of the first plurality of mantissa bits of the input data array and rounding the truncated subset of mantissa bits to generate the one or more mantissa bits of the output data array.

14. The compute unit of claim 13, wherein the scaling factor computed based on the first scale determination function reduces an error of rounding the truncated subset of mantissa bits to generate the one or more mantissa bits of the output data array compared to if the scaling factor was computed based on a second scale determination function of the plurality of scale determination functions.

15. The compute unit of claim 12, the circuitry configured to:
select the first plurality of mantissa bits based on determining a largest magnitude value element of the input data array and using a subset of the largest magnitude value element's mantissa bits as the first plurality of mantissa bits;
inspect the first plurality of mantissa bits of the input data array; and
select the first scale determination function based on a result of inspecting the first plurality of mantissa bits of the input data array, wherein the result is indicative of the data format conversion impact of converting the first plurality of mantissa bits of the input data array into one or more mantissa bits of the output data array having the target data format.

16. The compute unit of claim 11, wherein the first scale determination function increases a shared scale of the scaling factor for converting the input data array having the first data format to the output data array having the target data format compared to a second scale determination function of the plurality of scale determination functions.

17. The compute unit of claim 16, wherein the first scale determination function increases the shared scale for converting the input data array having the first data format to the output data array having the target data format by a power-of-two compared to a second scale determination function of the plurality of scale determination functions.

18. The compute unit of claim 11, wherein the first scale determination function is based on a scale that is set to be a largest power-of-two less than or equal to a maximum magnitude value in the input data array divided by a largest power-of-two representable in the target data format increased by an additional power-of-two.

19. The compute unit of claim 11, wherein the first data format is a single-precision floating point format, and the target data format is configured to occupy fewer bits than the single-precision floating point format.

20. (canceled)

21. A processing system comprising:
a memory configured to store an input data array having a first data format;
a compute unit configured to:
retrieve the input data array from the memory;
compute, for the input data array, a scaling factor based on a first scale determination function of a plurality of scale determination functions; and
convert the input data array into an output data array having a target data format based on the scaling factor to process the output data array at an artificial intelligence (AI) model, wherein the output data array occupies a smaller memory footprint than the input data array.

22. The processing system of claim 21, wherein the compute unit selects the first scale determination function from the plurality of scale determination functions based on a characteristic of the input data array, and wherein the characteristic is associated with a first plurality of mantissa bits of the input data array and a data format conversion impact of converting the first plurality of mantissa bits of the input data array into one or more mantissa bits of the output data array.

23. (canceled)
